(19) United States
(12) Patent Application Publication
(10) Pub. No.: US 2026/0246710 A1
(43) Pub. Date: Aug. 20, 2026

(54) SYSTEMS AND METHODS FOR AUTOMATICALLY AND DYNAMICALLY CONVERTING NON-WORKING NODES TO ACTIVE NODES IN A DISTRIBUTED NETWORK

(71) Applicant: BANK OF AMERICA CORPORATION, Charlotte, NC (US)

(72) Inventors: Durga Priya Adluru, Tega Cay, SC (US); Raja Arumugam Maharaja, Chennai (IN); Vinnodh Mohanasundaram, Namakkal (IN)

(73) Assignee: BANK OF AMERICA CORPORATION, Charlotte, NC (US)

(21) Appl. No.: 19/055,357

(22) Filed: Feb. 17, 2025

(51) Int. Cl. H04L 41/16; H04L 41/14

(52) U.S. Cl. CPC H04L 41/16; H04L 41/145

(57) ABSTRACT

Systems, computer program products, and methods are described herein for automatically and dynamically converting non-working nodes to active nodes in a distributed network. The present disclosure is configured to analyze, by an artificial intelligence model, nodes in a tangle network; identify, by the artificial intelligence model, at least one stale node, wherein the at least one stale node is a node in the tangle network that is a currently unused node; generate, by the artificial intelligence model, mock transmissions; and train, by the artificial intelligence model, the stale nodes using the mock transmissions, wherein such training configures the stale nodes to process future transmissions.

### TECHNOLOGICAL FIELD

The present disclosure is related generally to automatically and dynamically converting non-working nodes to active nodes in a distributed network and, more specifically, implementing Artificial Intelligence (AI), including Machine Learning (ML) to train non-working, ‘stale’ nodes in a tangle network to active nodes that can be used to process transmissions.

### BACKGROUND

Users may initiate data transmissions in a tangle network. Incoming data transmissions are processed based on existing nodes in the tangle network. However, some nodes in the tangle network may fall out of use for various reasons and become inactive or ‘stale’. Stale nodes cannot be used to process incoming data transmissions, thereby reducing the number of nodes in the tangle network that can process incoming data transmissions. The nodes that can be used to process incoming data transmissions may become overwhelmed. Stale nodes may, therefore, negatively impact the efficiency and overall performance of the tangle network, which may mean longer processing times or the failure of the tangle network to process some transmissions altogether.

Applicant has identified a number of deficiencies and problems associated with the performance of a tangle network in processing incoming data transmissions, as described above. Therefore, a need exists to develop systems, computerized methods, computer program products and the like that improves the efficiency of such networks by converting unused, stale nodes to usable active nodes. Through applied effort, ingenuity, and innovation, many of these identified problems have been solved by developing solutions that are included in embodiments of the present disclosure, many examples of which are described in detail herein.

### BRIEF SUMMARY

The following is a simplified summary of one or more embodiments of the disclosure in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present disclosure provide for systems, methods, computer program products and the like that provide for automatically and dynamically converting non-working nodes to active nodes in a distributed network. Specifically, the disclosure provided herein comprises an artificial intelligence (AI) model that analyzes all existing nodes in a tangle network identifies ‘stale’ nodes. The AI model then generates mock transmissions and trains the stale nodes using the mock transmissions, such that the trained nodes can be used to process future transmissions. In some embodiments of the disclosure, the AI model analyzes preferred nodes in the tangle network, which are nodes that are currently in use and determines certain properties of the preferred nodes that indicate the reasons why the preferred nodes are currently in use. The AI model uses those determined properties to generate the mock transmissions. In some embodiments of the disclosure, the AI model analyzes the incoming data transmission, determines the properties of the incoming data transmission, and generates mock transmissions based on those determined properties.

The disclosure further comprises a smart tipping selection algorithm that analyzes data associated with the existing nodes in the tangle network, including prior transmissions associated with the node. The smart tipping selection algorithm identifies and analyzes an incoming data transmission that was initiated by a user and is associated with a specified number of tokens assigned to the transmission by the user. The smart tipping selection algorithm then determines whether the incoming data transmission is a new transmission or a transmission with reference nodes. An incoming data transmission is a transmission with reference nodes if there is at least one existing node in the tangle network that is associated with data similar to the data associated with the incoming data transmission. The smart tipping selection algorithm makes this determination based on its analysis of the existing nodes in the tangle network. The smart tipping selection algorithm then directs the data transmission within the tangle network based on the determination.

In some embodiments of the disclosure, the smart tipping selection algorithm, upon analyzing the existing nodes in the tangle network and the incoming data transmission, determines whether all tokens assigned by the user to the incoming data transmission should be accepted. The smart tipping algorithm's analysis of the existing nodes in the tangle network may include an analysis of the number of tokens associated with prior transmissions processed by the existing nodes in the tangle network. Upon its determination and based on its analysis of the existing nodes and the incoming data transmission, the smart tipping selection algorithm accepts all the tokens assigned by the user or reassigns one or more of the tokens.

In some embodiments of the disclosure, the smart tipping selection algorithm directs the incoming data transmission to a validator block upon determining that the incoming data transmission is a transmission with reference nodes. In further embodiments of the disclosure, the smart tipping selection algorithm must determine the most appropriate validator block to direct the incoming data transmission to. The smart tipping selection algorithm determines the most appropriate validator block based on one or more factors, which may include, among others, the number of tokens associated with the incoming data transmission, the weight of the preferred nodes, the type of transmission of the incoming data transmission and the type of transmissions associated with the nodes in the validator block.

In some embodiments of the disclosure, the smart tipping selection algorithm redirects the incoming data transmission to one or more secondary validator blocks if the most appropriate validator block is saturated or nearing saturation (e.g., the most appropriate validator block has a high volume of traffic). In some embodiments, if all secondary validator blocks along with the most appropriate validator block are saturated or nearing saturation, then the smart tipping selection algorithm redirects the incoming data transmission to a reserve validator block.

In some embodiments of the disclosure, upon determining that the incoming data transmission is a new transmission, the smart tipping selection algorithm directs the incoming data transmission to a reserve validator block. In some embodiments of the disclosure, the reserve validator block comprises reserve validator nodes, which are stale nodes trained by the AI model using mock transmissions.

In some embodiments of the disclosure, the AI model provides feedback to the smart tipping selection algorithm on the stale nodes the AI model has trained and the smart tipping selection algorithm considers such feedback as a factor in determining how to direct the incoming data transmission. In some embodiments of the disclosure, the smart tipping selection algorithm works in conjunction with the AI model to ensure that all incoming data transmissions are processed by either a validator block or a reserve validator block. In some embodiments of the disclosure, the smart tipping selection algorithm distributes incoming data transmissions evenly across all nodes in the tangle network to ensure the efficient processing of all incoming data transmissions.

As such, the present disclosure provides for automatically and dynamically converting non-working nodes to active nodes in a distributed network to improve the overall performance of the network and ensure all nodes in the network are actively and efficiently processing transmissions.

A system for automatically and dynamically converting non-working nodes to active nodes in a distributed network defines an embodiment of the disclosure provided herein. The system comprises a memory device comprising non-transitory computer-readable medium with computer-readable program code stored on the memory device. The system further comprises at least one processing device operatively coupled to the at least one memory device and at least one communication device. When executed, the computer-readable code is configured to cause the at least one processing device to analyze nodes in a tangle network, identify at least one stale node in the tangle network, generate mock transmissions, and train the stale nodes using the mock transmissions. The at least one stale node is a node in the tangle network that is a currently unused node. In some embodiments of the disclosure, an AI model analyzes the nodes in the tangle network, identifies the at least one stale node, generates mock transmissions, and trains the at least one stale node. Training a stale node configures the stale node to process future transmissions.

In some embodiments of the disclosure, the computer-readable code is further configured to cause the at least one processing device to: analyze, preferred nodes, determine certain properties of the preferred nodes, wherein the certain properties of the preferred nodes indicate the reasons for the current use of the preferred nodes, and generate the mock transmissions based on the certain properties of the preferred nodes. Preferred nodes are nodes in the tangle network that are currently in use. In some embodiments of the disclosure, an AI model analyzes the preferred nodes, determines the certain properties of the preferred nodes, and generates the mock transmissions. In some embodiments of the disclosure, the computer-readable code is further configured to cause the at least one processing device to analyze an incoming data transmission, determine properties of the incoming data transmission, and generate the mock transmissions based on the properties of the incoming data transmission. In some embodiments of the disclosure, an AI model analyzes the incoming data transmission, determines the properties of the incoming data transmissions, and generates the mock transmissions.

In some embodiments of the disclosure, the system further comprises a smart tipping selection algorithm. The smart tipping selection algorithm is configured to analyze data associated with the nodes in the tangle network, wherein the data associated with the nodes comprises prior transmissions associated with the nodes. The smart tipping selection algorithm is further configured to identify an incoming data transmission. The incoming data transmission is initiated by a user and is associated with a specified number of tokens assigned by the user. The smart tipping selection algorithm is further configured to determine whether the incoming data transmission is a new transmission or a transmission with reference nodes based on an analysis of the data associated with the nodes in the tangle network. Reference nodes are nodes in the tangle network with associated data that is similar to the incoming data transmission. The smart tipping selection algorithm is further configured to direct the incoming data transmission within the tangle network.

In some embodiments of the disclosure, the AI model provides feedback to the smart tipping selection algorithm regarding the AI model's training of stale nodes. The smart tipping selection algorithm directs the incoming data transmission within the tangle network based on the feedback. In some embodiments of the disclosure, the smart tipping selection algorithm is further configured to distribute incoming data transmissions evenly across all nodes of the tangle network. In some embodiments of the disclosure, the smart tipping selection algorithm and the AI model work in conjunction to ensure all incoming data transmissions are processed by either a validator block or a reserve validator block.

In some embodiments of the disclosure, the smart tipping selection algorithm directs the incoming transmission to a validator block upon determining that the incoming transmission is the transmission with reference nodes. In some embodiments of disclosure, the smart tipping selection algorithm is configured to direct the incoming transmission to a reserve validator block upon determining that the incoming transmission is the new transmission. In some embodiments of the disclosure, the reserve validator block comprises reserve validator nodes, wherein the reserve validator nodes are stale nodes that are trained by the AI model using the mock transmissions.

In some embodiments of the disclosure, the smart tipping selection algorithm directs the incoming data transmission to a most appropriate validator block. The most appropriate validator block is determined based on one or more factors. The one or more factors comprise the number of tokens associated with the incoming data transmission, weightage of the preferred nodes, a transmission type of the incoming data transmission, or a transmission type associated with the nodes in the validator block.

In some embodiments of the disclosure, the smart tipping selection algorithm redirects the incoming data transmission to one of one or more secondary validator blocks if the most appropriate validator block is saturated or is nearing saturation. In some embodiments, the smart tipping selection algorithm redirects the incoming data transmission to a reserve validator block if all of the most appropriate validator block and the one or more secondary validator blocks are saturated or are nearing saturation. Saturation is determined by analyzing the volume of traffic to a validator block.

In some embodiments of the disclosure, the smart tipping selection algorithm is further configured to analyze the incoming data transmission, determine whether all tokens assigned by the user should be accepted, and accept all the tokens or reassigns one or more of the tokens. The smart tipping selection algorithm determines whether all tokens should be accepted based on the analysis of the data associated with the nodes in the tangle network. Data associated with the nodes further comprises the number of tokens associated with the prior transmissions associated with the nodes. The smart tipping selection algorithm reassigns one or more tokens based on the number of tokens associated with the prior transmissions.

A computer-implemented method for automatically and dynamically converting non-working nodes to active nodes in a distributed network defines second embodiments of the disclosure. The computer-implemented method is executed by one or more computing processor devices. The method comprises using an AI model to analyze nodes in a tangle network, identify at least one stale node, generate mock transmissions, and train the stale node(s) using the mock transmissions. A stale is a node in the tangle network that is a currently unused node. Training configures the stale nodes to process future transmissions. In some embodiments of the disclosure, the method further comprises using the AI model to analyze preferred nodes, determine certain properties of the preferred nodes, and generate mock transmissions based on the certain properties of the preferred nodes. Preferred nodes are nodes in the tangle network that are currently in use. The determined certain properties of the preferred nodes indicate the reasons for the current use of the preferred nodes. In some embodiments of the disclosure, the method further comprises using the AI model to analyze an incoming data transmission, determine properties of the incoming data transmission, and generate the mock transmissions based on the properties of the incoming data transmission.

In some embodiments of the disclosure, the method further comprises analyzing data associated with the nodes in the tangle network, identifying an incoming data transmission, determining whether the incoming data transmission is a new transmission or a transmission with reference nodes based on an analysis of the data associated with the nodes in the tangle network, and directing the incoming data transmission within the tangle network. The data associated with the nodes comprises prior transmissions associated with the nodes. The incoming data transmission is initiated by a user and is associated with a specified number of tokens assigned by the user. Reference nodes are nodes in the tangle network with associated data that is similar to the incoming data transmission. In some embodiments of the disclosure, the method further comprises using feedback on the trained nodes to direct the incoming data transmission. In some embodiments of the disclosure, the method further comprises distributing incoming data transmissions evenly across all nodes of the tangle network. In some embodiments of the disclosure, the method further comprises ensuring all incoming data transmissions are processed by either a validator block or a reserve validator block. In some embodiments of the disclosure, the method further comprises directing the incoming transmission to a validator block upon determining that the incoming transmission is the transmission with reference nodes. In some embodiments of disclosure, the method further comprises directing the incoming transmission to a reserve validator block upon determining that the incoming transmission is the new transmission. In some embodiments of the disclosure, the reserve validator block comprises reserve validator nodes, wherein the reserve validator nodes are stale nodes that are trained by the AI model using the mock transmissions. In some embodiments of the disclosure, the method further comprises directing the incoming data transmission to a most appropriate validator block. The most appropriate validator block is determined based on one or more factors. The one or more factors comprise the number of tokens associated with the incoming data transmission, weightage of the preferred nodes, a transmission type of the incoming data transmission, or a transmission type associated with the nodes in the validator block. In some embodiments of the disclosure, the method further comprises redirecting the incoming data transmission to one of one or more secondary validator blocks if the most appropriate validator block is saturated or is nearing saturation. In some embodiments, the method further comprises redirecting the incoming data transmission to a reserve validator block if all of the most appropriate validator block and the one or more secondary validator blocks are saturated or are nearing saturation. Saturation is determined by analyzing the volume of traffic to a validator block. In some embodiments of the disclosure, the method further comprises analyzing the incoming data transmission, determining whether all tokens assigned by the user should be accepted, and accepting all the tokens or reassigning one or more of the tokens. The method comprises determining whether all tokens should be accepted based on the analysis of the data associated with the nodes in the tangle network. Data associated with the nodes further comprises the number of tokens associated with the prior transmissions associated with the nodes. The method further comprises reassigning one or more tokens based on the number of tokens associated with the prior transmissions.

A computer program product for automatically and dynamically converting non-working nodes to active nodes in a distributed network including a non-transitory computer-readable medium defines third embodiments of the disclosure. The computer-readable medium includes computer-readable program code portions embodied therein, the computer-readable program code portions which when executed by a processing device are configured to cause the processing device to analyze nodes in a tangle network, identify at least one stale node in the tangle network, generate mock transmissions, and train the at least one stale node using the mock transmissions. Stale nodes are nodes in the tangle network that are currently unused or non-working. Training a stale node using the mock transmissions configures the stale node to process future transmissions. In some embodiments of the disclosure, the mock transmissions are generated based on properties of preferred nodes in the tangle network, where preferred nodes are nodes that are working or currently in use. In some embodiments, the mock transmissions are generated based on properties of one or more incoming data transmissions.

In some embodiments of the disclosure, the computer-readable program code portions are further configured to cause the processing device to analyze data associated with the nodes in the tangle network, identify an incoming data transmission, determine whether the incoming data transmission is a new transmission or a transmission with reference nodes, and direct the incoming data transmission within the tangle network. Data associated with the nodes in the tangle network comprises prior transmissions associated with the nodes. Incoming data transmissions are initiated by a user and are associated with a specific number of tokens assigned by the user. In some embodiments of the disclosure, the computer-readable program code portions are further configured to cause the processing device to reassign one or more tokens based on an analysis of the prior transmissions processed in the tangle network. In some embodiments of the disclosure, the incoming data transmission is determined to be a new transmission or a transmission with reference nodes based on the analysis of the data associated with the nodes in the tangle network. In some embodiments of the disclosure, the computer-readable program code portions are further configured to cause the processing device to direct the incoming data transmission within the tangle network based on the determination of whether the incoming data transmission is a new transmission or a transmission with reference nodes.

In some embodiments, the computer-readable program code portions are further configured to cause the processing device to direct transmissions with reference nodes to a validator block. In some embodiments, the computer-readable program code portions are further configured to cause the processing device to direct new transmissions to a reserve validator block, where the reserve validator block comprises reserve validator nodes that are trained stale nodes. In some embodiments, the computer-readable program code portions are further configured to cause the processing device to direct the incoming data transmission to a most appropriate validator block, where the most appropriate validator block is determined based on one or more factors, such as the number of tokens associated with the incoming data transmission, weightage of the preferred nodes, or transmission type associated with the nodes in the tangle network and of the incoming data transmission. In some embodiments of the disclosure, the computer-readable program code portions are further configured to cause the processing device to redirect the incoming data transmission to one or more secondary validator blocks if the most appropriate validator block is nearing saturation, or to a reserve validator block if all the secondary validator blocks are also nearing saturation. In some embodiments of the disclosure, the computer-readable program code portions are further configured to cause the processing device to distribute all incoming data transmissions evenly across the nodes in the tangle network. In some embodiments of the disclosure, the computer-readable program code portions are further configured to cause the processing device to ensure that all incoming data transmissions are processed in the tangle network.

Thus, according to embodiments of the disclosure, which will be discussed in greater detail below, the present disclosure provides for automatically and dynamically converting non-working nodes to active nodes in a distributed network to improve the overall performance of the network and ensure all transmissions are efficiently processed by the network. Specifically, the disclosure uses an AI model to identify stale nodes in a tangle network by first analyzing all nodes in the tangle network, generating mock transmissions and training the stale nodes using the mock transmissions to convert the stale, unused nodes into active, usable nodes. In some embodiments, the AI model may analyze preferred nodes (nodes currently in use) in the tangle network, determine properties of the preferred nodes that cause the preferred nodes to be usable, and use the determined properties to generate the mock transmissions. In some embodiments, the AI model may analyze an incoming data transmission, determine properties of the incoming data transmission, and use the determined properties to generate the mock transmissions. The disclosure also comprises a smart tipping selection algorithm that analyzes data associated with all the nodes in the tangle network, identifies and analyzes an incoming data transmission, determines whether the incoming data transmission is new transmission or is a transmission with reference nodes, and directs the incoming data transmission within the tangle network based on the determination. In some embodiments, the smart tipping selection algorithm directs transmissions with reference nodes to a validator block and in other embodiments, the smart tipping selection algorithm directs a new transmission to a reserve validator block. In some embodiments, the smart tipping selection algorithm has to decide which validator block to direct the incoming data transmission to, and makes that decision based on one or more factors, including, among others, the number of tokens associated with the incoming data transmission, weight of the preferred nodes, and the transmission type associated with the incoming data transmission and the nodes in the validator block. The smart tipping selection algorithm first directs the incoming data transmission to the most appropriate validator block but may redirect to a secondary validator block if the most appropriate validator block is nearing saturation, or to a reserve validator block is the most appropriate validator block and all secondary validator blocks are nearing saturation. In some embodiments, the reserve validator block comprises reserve validator nodes, which are stale nodes trained by the AI model. In some embodiments, the incoming data transmission, initiated by a user, is associated with a specified number of tokens assigned to the incoming data transmission by the user. In further embodiments, the smart tipping selection algorithm analyzes the number of tokens associated with prior transmissions similar to the incoming data transmission that have already been processed in the tangle network and determines whether to accept all the incoming data transmission's tokens or not. Upon determining not to accept all the incoming data transmission's tokens, the smart tipping selection algorithm can reassign one or more of the tokens. In some embodiments of the disclosure, the AI model provides feedback to the smart tipping selection algorithm regarding the stale nodes it trains, and the smart tipping selection algorithm may consider such feedback in determining how to direct the incoming data transmission. The smart tipping algorithm and AI model work together to distribute incoming data transmissions evenly across all nodes of the tangle network and to ensure that all incoming data transmissions are processed.

The above summary is provided merely for purposes of summarizing some example embodiments to provide a basic understanding of some aspects of the present disclosure. The features, functions, and advantages that have been discussed may be achieved independently in various embodiments of the present disclosure or may be combined with yet other embodiments, further details of which can be seen with reference to the following description and drawings. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatically and dynamically converting non-working nodes to active nodes in a distributed network, in accordance with an embodiment of the disclosure;

FIG. 2 illustrates an exemplary artificial intelligence (AI) subsystem architecture, in accordance with an embodiment of the disclosure;

FIGS. 3A-3B illustrate an exemplary distributed ledger technology (DLT) architecture, in accordance with an embodiment of the disclosure;

FIG. 4 illustrates a process flow for automatically and dynamically converting non-working nodes to active nodes in a distributed network, in accordance with an embodiment of the disclosure;

FIG. 5 illustrates a process flow for generating mock transmissions based on an analysis of preferred nodes, in accordance with an embodiment of the disclosure;

FIG. 6 illustrates a process flow for generating mock transmissions based on an analysis of incoming data transmissions, in according with an embodiment of the disclosure;

FIG. 7 illustrates a process flow directing incoming data transmissions within the tangle network, in accordance with an embodiment of the disclosure;

FIG. 8 illustrates a process flow for accepting or rejecting tokens associated with an incoming data transmission, in accordance with an embodiment of the disclosure;

FIG. 9 illustrates a process flow for directing incoming data transmissions within a tangle network, in accordance with an embodiment of the disclosure;

FIG. 10 illustrates a tangle network architecture, in accordance with an embodiment of the disclosure; and

FIGS. 11A-11B illustrate a process flow for directing incoming data transmissions within a tangle network with token utilization, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As will be appreciated by one of skill in the art in view of this disclosure, the present disclosure may be embodied as a system, a method, a computer program product or a combination of the foregoing. Accordingly, embodiments of the present disclosure may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present disclosure may take the form of a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present disclosure may be written in an object oriented, scripted or unscripted programming language such as JAVA, PERL, SMALLTALK, C++, PYTHON or the like. However, the computer program code/computer-readable instructions for carrying out operations of the disclosure may also be written in conventional procedural programming languages, such as the “C” programming language or similar programming languages.

Embodiments of the present disclosure are described below with reference to flowchart illustrations and/or block diagrams of method or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the disclosure.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “satisfying the threshold” or “meeting the threshold” may, depending on the context, refer to a value being greater than the threshold, more than the threshold, higher than the threshold, greater than or equal to the threshold, equal to the threshold, or the like.

According to embodiments of the disclosure, which will be described in more detail below, systems, methods and computer program products are disclosed that provide for automatically and dynamically converting non-working nodes to active nodes in a distributed network. Specifically, the disclosure provides for training stale nodes in a tangle network to be able to process future transmissions and directing incoming data transmissions to distribute incoming data transmissions evenly across the tangle network and ensure all incoming data transmissions are processed efficiently.

In standard tangle network transmission processing, a user initiates a transmission and introduce the transmission to the tangle network. When the user initiates the transmission, the user assigns some number of tokens to the transmission. A standard tipping selection algorithm directs incoming data transmissions to existing nodes within the tangle network. The existing nodes in the tangle network process the incoming data transmissions and existing nodes in the tangle network can represent various types of transmissions. The number of tokens associated with a transmission essentially represents the weight that transmission needs to be given by the standard tipping selection algorithm, i.e., the standard tipping selection algorithm prioritizes transmissions with higher number of tokens. Existing nodes that process high-token transmissions would have a higher weightage too. The standard tipping selection algorithm would send the highest priority incoming data transmissions to the existing nodes with the highest weightage. However, users can essentially assign any number of tokens to a transmission as they want and users who want their transmission to be prioritized would simply assign a high number of tokens. This can lead to various problems. For one, a user may assign a higher number of tokens to a particular transmission than is actually required for that transmission or for a transmission of that particular type. Then, if most incoming data transmissions are high priority transmissions that need to be processed by the high weightage nodes, then lower weightage nodes can fall out of use because incoming data transmissions are not being sent to such lower weightage nodes. Such lower weightage nodes can become stale, which would negatively impact the overall performance of the tangle network. Additionally, transmissions with lower number of assigned tokens may be sent to stale nodes, which may result in long wait times to be processed. In some instances, such transmissions may get ‘dropped’ in the tangle network, essentially never being fully processed. Such dropped transmissions may become stale nodes themselves. Furthermore, when there are several high priority transmissions that are waiting for high weightage nodes for processing, such high weightage nodes may become saturated, leading to longer wait times and slower processing times, for example.

A smart tipping selection algorithm that works in conjunction with an artificial intelligence (AI) model to train stale nodes to process transmissions and direct these incoming data transmissions to all nodes, including trained stale nodes based on not only the priority level of the incoming data transmission but also the volume of traffic to the nodes in the tangle network can address each of the problems presented by the standard tangle network transmission processing. If the AI model trains a stale node by feeding it mock transmissions that are based on the high weightage nodes, then the stale node can be converted into an active node and may gain in weightage satisfies the threshold to process incoming data transmissions, thus reducing the burden on the high weightage nodes. Furthermore, the smart tipping selection algorithm may be configured to address the problem with token assignments up front by rejecting one or more tokens assigned to a transmission by the user, if the smart tipping selection algorithm determines, based on an analysis of previous transmissions processed in the tangle network, that the number of tokens assigned by the user is too high.

Accordingly, the present disclosure provides for an artificial intelligence (AI) model that analyzes all existing nodes in a tangle network, a distributed network that utilizes a directed acyclic graph structure and identifies ‘stale’ nodes, which are nodes that are currently unused in the tangle network in processing incoming data transmissions. The AI model then generates mock transmissions and trains the stale nodes using the mock transmissions, such that the trained nodes can be used to process future transmissions. In some embodiments of the disclosure, the AI model analyzes preferred nodes in the tangle network, which are nodes that are currently in use and determines certain properties of the preferred nodes that indicate the reasons why the preferred nodes are currently in use. The AI model uses those determined properties to generate the mock transmissions. In some embodiments of the disclosure, the AI model analyzes the incoming data transmission, determines the properties of the incoming data transmission, and generates mock transmissions based on those determined properties.

The disclosure may further comprise a smart tipping selection algorithm that analyzes data associated with the existing nodes in the tangle network, including prior transmissions associated with the node. The smart tipping selection algorithm may identify and analyze an incoming data transmission that was initiated by a user and is associated with a specified number of tokens assigned to the transmission by the user. The smart tipping selection algorithm may then determine whether the incoming data transmission is a new transmission or a transmission with reference nodes. An incoming data transmission is a transmission with reference nodes if there is at least one existing node in the tangle network that is associated with data similar to the data associated with the incoming data transmission. The smart tipping selection algorithm may make this determination based on its analysis of the existing nodes in the tangle network. The smart tipping selection algorithm may then directs the incoming data transmission within the tangle network based on the determination of whether the incoming data transmission is a new transmission or a transmission with reference nodes.

In some embodiments of the disclosure, the smart tipping selection algorithm, upon analyzing the existing nodes in the tangle network and the incoming data transmission, may determine whether all tokens assigned by the user to the incoming data transmission should be accepted. The smart tipping algorithm's analysis of the existing nodes in the tangle network may include an analysis of the number of tokens associated with prior transmissions processed by the existing nodes in the tangle network. Upon its determination, and based on its analysis of the existing nodes and the incoming data transmission, the smart tipping selection algorithm may accept all the tokens assigned by the user or reassign one or more of the tokens to one or more other incoming data transmissions in the tangle network.

In some embodiments of the disclosure, the smart tipping selection algorithm may direct the incoming data transmission to a validator block upon determining that the incoming data transmission is a transmission with reference nodes. In further embodiments of the disclosure, the smart tipping selection algorithm may determine the most appropriate validator block to direct the incoming data transmission to. The smart tipping selection algorithm may determine the most appropriate validator block based on one or more factors, which may include, among others, the number of tokens associated with the incoming data transmission, the weight of the preferred nodes, the type of transmission of the incoming data transmission and/or the type of transmissions associated with the nodes in the validator block.

In some embodiments of the disclosure, the smart tipping selection algorithm redirects the incoming data transmission to one or more secondary validator blocks if the most appropriate validator block is saturated or nearing saturation (e.g., the most appropriate validator block has a high volume of traffic). In some embodiments, if all secondary validator blocks along with the most appropriate validator block are saturated or nearing saturation, then the smart tipping selection algorithm may redirect the incoming data transmission to a reserve validator block.

In some embodiments of the disclosure, upon determining that the incoming data transmission is a new transmission, the smart tipping selection algorithm may direct the incoming data transmission to a reserve validator block. In some embodiments of the disclosure, the reserve validator block comprises reserve validator nodes, which are stale nodes trained by the AI model using mock transmissions.

In some embodiments of the disclosure, the AI model provides feedback to the smart tipping selection algorithm on the stale nodes the AI model has trained, and the smart tipping selection algorithm considers such feedback as a factor in determining how to direct the incoming data transmission. In some embodiments of the disclosure, the smart tipping selection algorithm works in conjunction with the AI model to ensure that all incoming data transmissions are processed by either a validator block or a reserve validator block. In some embodiments of the disclosure, the smart tipping selection algorithm, distributes incoming data transmissions evenly across all nodes in the tangle network to ensure the efficient processing of all incoming data transmissions.

What is more, the present disclosure provides a technical solution to a technical problem. As described herein, the technical problem includes stale nodes in a distributed (e.g., tangle) network negatively impacting the performance of the network and the inefficient processing of incoming data transmissions in the network. The technical solution presented herein allows for an artificial intelligence model and a smart tipping selection algorithm that work in conjunction to train stale nodes to become active nodes, thus improving the performance of the tangle network, and directing incoming data transmissions throughout the tangle network to ensure that all incoming data transmissions are processed in an efficient manner. In particular, the smart tipping selection algorithm that works in conjunction with an artificial intelligence model is an improvement over existing solutions to the processing of transmissions in a tangle network, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

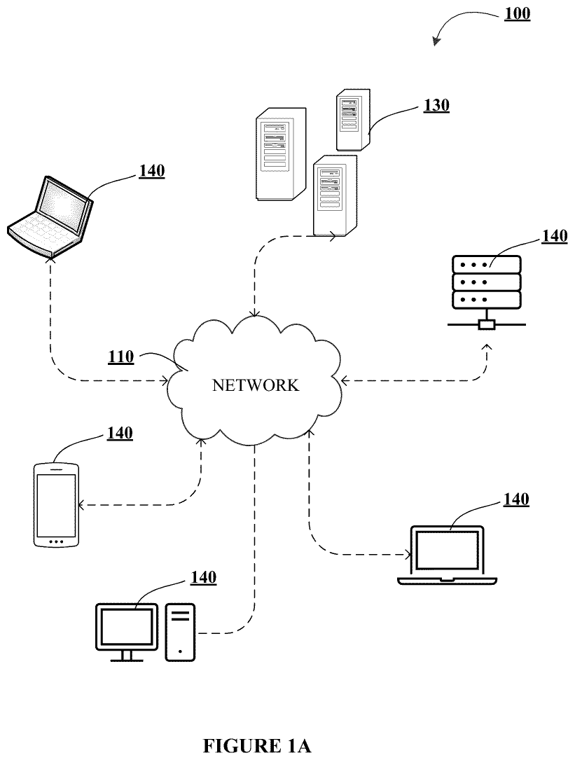

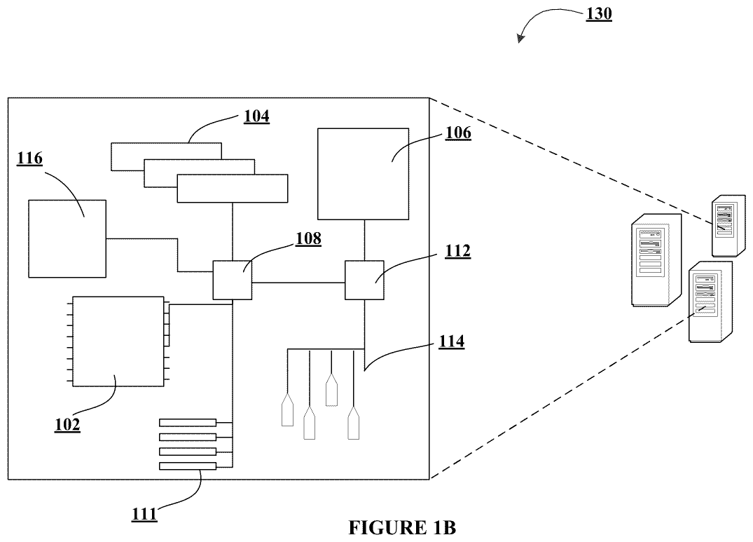

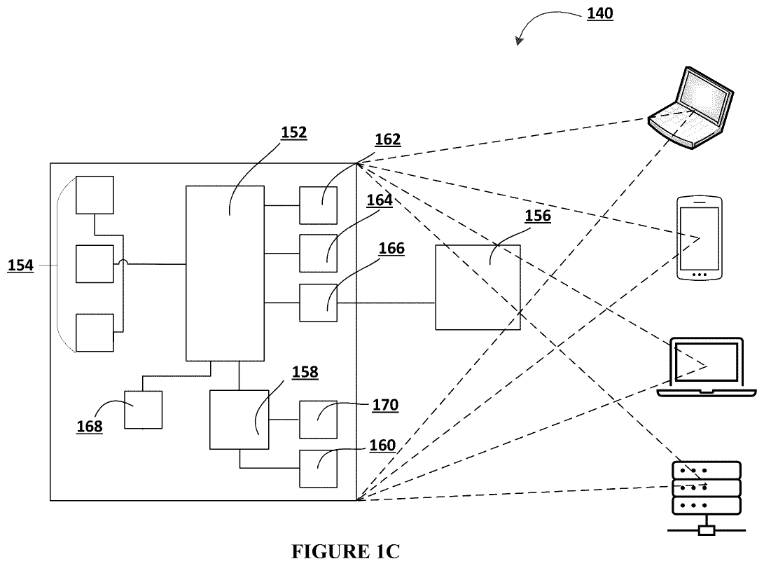

FIGS. 1A-1C illustrate technical components of an exemplary distributed computing environment for automatically and dynamically converting non-working nodes to active nodes in a distributed network 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

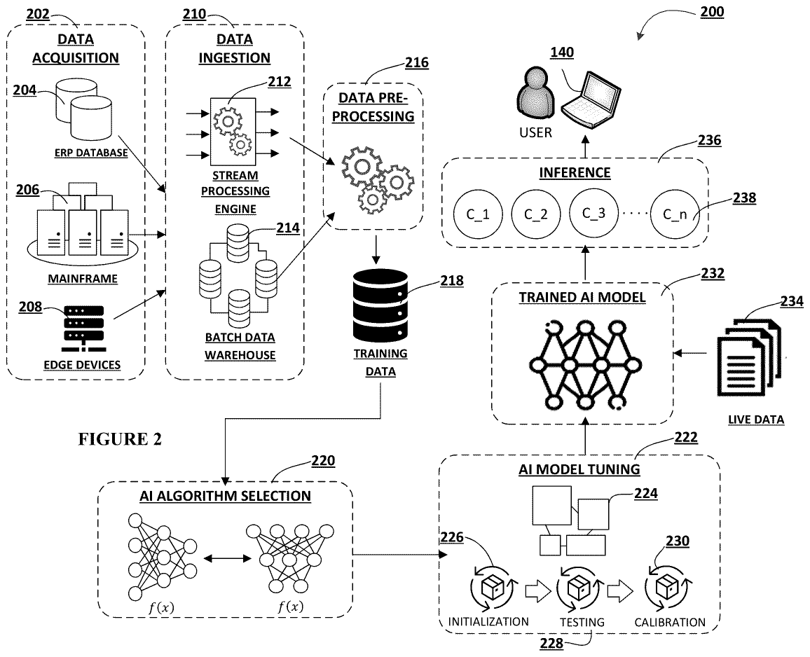

FIG. 2 illustrates an exemplary artificial intelligence (AI) subsystem architecture 200, in accordance with an embodiment of the disclosure. The artificial intelligence subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the artificial intelligence model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence model 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so an artificial intelligence model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI model tuning engine 222 may be used to train an artificial intelligence model 224 using the training data 218 to make predictions or decisions without explicitly being programmed to do so. The artificial intelligence model 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable artificial intelligence model type. Each of these types of artificial intelligence algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the artificial intelligence model, the AI model tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the artificial intelligence model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained artificial intelligence model 232 is one whose hyperparameters are tuned and model accuracy maximized.

The trained artificial intelligence model 232, similar to any other software application output, can be persisted to storage, file, memory, or application, or looped back into the processing component to be reprocessed. More often, the trained artificial intelligence model 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence models that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

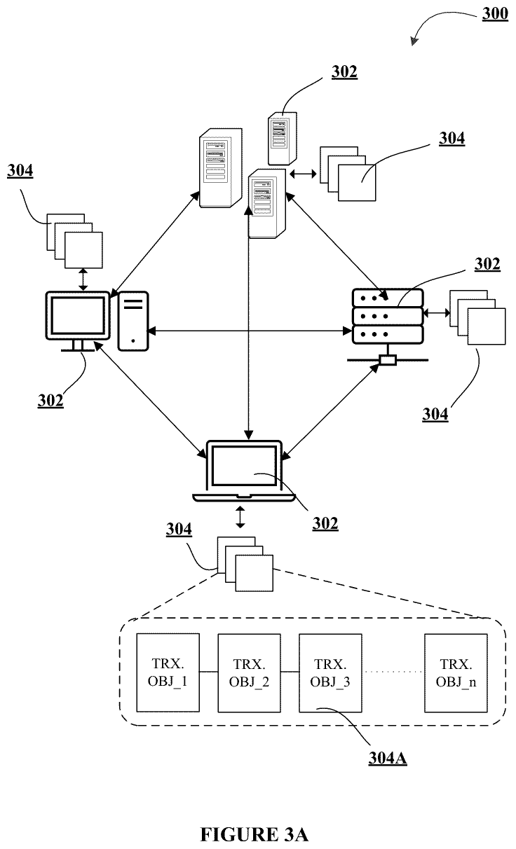

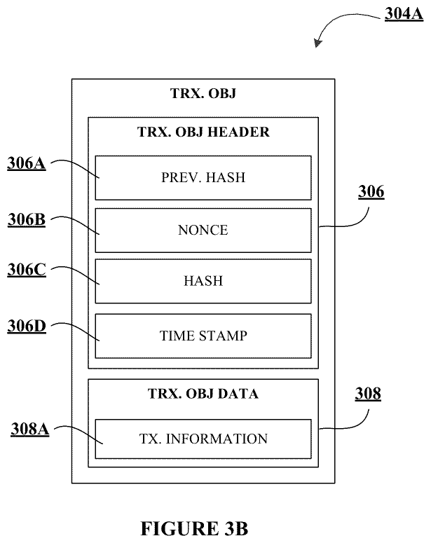

FIGS. 3A-3B illustrate an exemplary distributed ledger technology (DLT) architecture, in accordance with an embodiment of the disclosure. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 3A, the exemplary DLT architecture 300 includes a distributed ledger 304 being maintained on multiple devices (nodes) 302 that are authorized to keep track of the distributed ledger 304. For example, these nodes 302 may be computing devices such as system 130 and client device(s) 140. One node 302 in the DLT architecture 300 may have a complete or partial copy of the entire distributed ledger 304 or set of transactions and/or transaction objects 304A on the distributed ledger 304. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 3B, an exemplary transaction object 304A may include a transaction header 306 and a transaction object data 308. The transaction header 306 may include a cryptographic hash of the previous transaction object 306A, a nonce 306B-a randomly generated 32-bit whole number when the transaction object is created, cryptographic hash of the current transaction object 306C wedded to the nonce 306B, and a time stamp 306D. The transaction object data 308 may include transaction information 308A being recorded. Once the transaction object 304A is generated, the transaction information 308A is considered signed and forever tied to its nonce 306B and hash 306C. Once generated, the transaction object 304A is then deployed on the distributed ledger 304. At this time, a distributed ledger address is generated for the transaction object 304A, i.e., an indication of where it is located on the distributed ledger 304 and captured for recording purposes. Once deployed, the transaction information 308A is considered recorded in the distributed ledger 304.

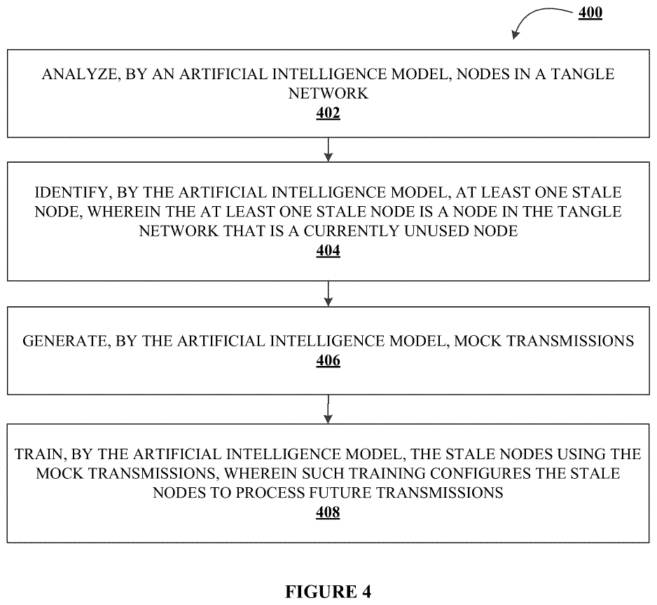

FIG. 4 illustrates a process flow 400 for automatically and dynamically converting non-working nodes to active nodes in a distributed network, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400. Additionally, and in some embodiments, an AI model (like the AI model shown and described above with respect to FIG. 2) and/or a DLT ledger (like that shown and described above with respect to FIGS. 3A-3B) may perform one or more of the step of process flow 400.

As shown in block 402, the process flow 400 may include the step of analyzing nodes in a tangle network. A tangle network is a type of distributed network that utilizes a directed acyclic graph structure and comprises multiple nodes. Transmissions may be introduced into a tangle network and processed by the nodes in the tangle network. In some embodiments of the disclosure, an artificial intelligence (AI) model analyzes the nodes in the tangle network. In some embodiments of the disclosure, nodes in the tangle network are associated with certain data. Such data may include the processing history of the node, where the processing history comprises one or more transmissions previously processed by the node. In some embodiments, transmissions previously processed by the node are associated with a certain number of tokens and the data associated with the nodes may include the number of tokens associated with the transmissions processed by each node. Further, in some embodiments, each node may be associated with a certain weight. Such weight may be determined by the number of tokens associated with the initial transmission processed in association with the node and by the number of tokens associated with any transmissions processed by the node thereafter. Data associated with the node may include the node's weightage as well.

As shown in block 404, the process flow 400 may include the step of identifying at least one stale node in the tangle network. A stale node is a node in the tangle network that is currently unused, non-working or otherwise inactive. A node may be unused, non-working, or otherwise inactive if it is unable to process transmissions. In some embodiments of the disclosure, the AI model identifies stale nodes in the tangle network. In some embodiments of the disclosure, stale nodes may be identified based on the AI model's analysis of all nodes in the tangle network. In some embodiments of the disclosure, a smart tipping selection algorithm may analyze the nodes in the tangle network and the AI model may work with the smart tipping selection algorithm to identify the stale nodes. Whether or not a node is stale may be determined based on the node's processing history, the strength of the transmissions processed by the node (transmissions with higher number of tokens attached would be stronger transmissions, for example), and the weightage of the node. For example, a node that has only processed one low-token transmission and has not processed any transmissions in a long time may be considered a stale node. However, a node that has a long history of processing strong, high-token transmissions, but has not processed any transmissions in a while, may not yet be considered a stale node.

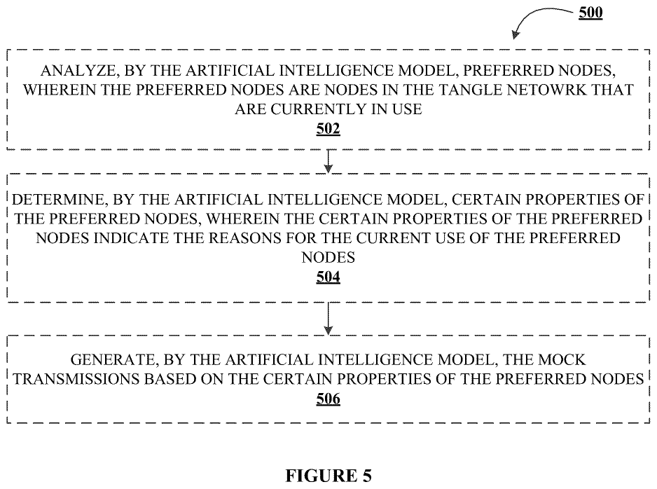

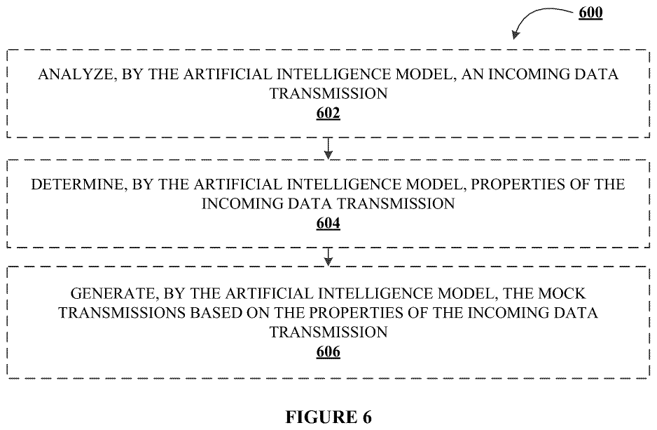

As shown in block 406, the process flow 400 may include the step of generating mock transmissions. In some embodiments of the disclosure, the mock transmissions are generated by the AI model. In some embodiments of the disclosure, the mock transmissions are meant to emulate real transmissions processed by the tangle network. For example, and in some embodiments, the mock transmission may mirror the properties of a preferred node or, as another example, the mock transmission may combine properties of multiple preferred nodes. In some embodiments, the mock transmissions are modeled after transmissions that are predicted to be processed by the tangle network in the future. For example, the AI model may determine, based on previous transmissions introduced to and processed in the tangle network, that certain types of transmissions or transmissions with certain properties are more likely to be introduced and processed in the tangle network than others. Therefore, the AI model may generate mock transmissions of such certain types or with such certain properties. In some embodiments of the disclosure, the mock transmissions are generated based on existing nodes in the tangle network, as further detailed in FIG. 5 and the description of FIG. 5 below. In some embodiments of the disclosure, the mock transmissions are generated based on incoming data transmissions that are yet to be processed in the tangle network, as further detailed in FIG. 6 and the description of FIG. 6 below.

As shown in block 408, the process flow 400 may include the step of training the stale nodes using the mock transmissions. In some embodiments of the disclosure, the stale nodes are trained by the AI model. In some embodiments, training a stale node using mock transmissions essentially means feeding or inputting the stale node mock transmissions for the stale node to process. In some embodiments, training the stale node configures the stale node to process future transmissions. For example, and in some embodiments, a stale node may have become stale because it was associated with an outdated transmission type that is no longer being introduced into the tangle network, and therefore not being processed by the tangle network. By feeding the stale mock transmissions that are of a more common transmission type, the stale node may be better equipped to process future transmissions of that transmission type. Further, in some embodiments, and as described in more detail herein, a smart tipping selection algorithm may direct incoming data transmissions of the transmission type that the stale node has been trained with to the stale node for the stale node to process. In this way, the stale node may be converted to an active node.

FIG. 5 illustrates a process flow 500 for generating mock transmissions based on an analysis of preferred nodes, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500. Additionally, and in some embodiments, an AI model (like the AI model shown and described above with respect to FIG. 2) and/or a DLT ledger (like that shown and described above with respect to FIGS. 3A-3B) may perform one or more of the step of process flow 500.

As shown in block 502, the process flow 500 may include the step of analyzing preferred nodes in the tangle network. Preferred nodes in the tangle network are active nodes or nodes that are currently in use (i.e., nodes that process transmissions in the tangle network). In some embodiments of the disclosure, preferred nodes are identified and analyzed by the AI model. In some embodiments of the disclosure, nodes may lie at various points on a spectrum of activity. For example, a tangle network with five nodes, may have a node that has never processed a transmission, a node that has a long history of processing transmissions but hasn't processed a transmission in a long time (for example, a node that hasn't processed any of the last 5,000 incoming data transmissions, but has consistently processed transmissions before that), a node that processes weak or low-token transmissions every once in a while (for example, a node that processes one low-token transmission for every 500 transmissions that are processed in the tangle network), a node that processes strong, high-token transmissions every once in a while (for example, a node that processes one high-token transmission for every 500 transmissions that are processed in the tangle network), and node that processes consistently and continuously processes strong, high-token transmissions. Each of these nodes may range from stale to preferred in that order, with the node that has never processed a transmission being a stale node, the node that sporadically processes weak transmissions in danger of becoming stale over time, the node that sporadically processes strong transmissions being an active, preferred node, and the node that consistently processes strong transmissions being the most preferred node, for example. In some embodiments of the disclosure, identifying preferred nodes includes identifying how preferred the node is-where the node lies on the spectrum, for example. In some embodiments of the disclosure, and as described in further detail below, analyzing the preferred nodes includes identifying and analyzing the various properties of the preferred nodes.

As shown in block 504, the process flow 500 may include the step of determining certain properties of the preferred nodes that indicate the reasons for the current use of the preferred nodes. For example, the AI model may determine that the preferred nodes consistently process the most common type of incoming data transmission, whereas the stale nodes have never processed that most common type of incoming data transmission. The AI model may then generate mock transmissions that are of that most common type of incoming data transmission and feed those mock transmissions to the stale nodes to train the stale nodes to process that type of transmission. In some embodiments of the disclosure, the AI model determines the certain properties of the preferred nodes. In some embodiments of the disclosure, analyzing preferred nodes essentially includes understanding what makes the node preferred and determining the certain properties of the preferred node includes identifying the specific properties of the node that cause the node to be preferred. For example, properties of nodes may include the transmission type(s) associated with the nodes. The AI model may analyze the nodes to identify the transmission type associated with each node, for example, and determine that all the preferred nodes are associated with transmission type A. In some embodiments of the disclosure, analyzing preferred nodes includes understanding what makes a node more preferred than another node and determining the certain properties of the preferred nodes includes identifying the properties of the most preferred nodes that cause the nodes to be most preferred. For example, following the example above, the AI model may determine that the most preferred nodes are associated with transmission type A, but many other preferred nodes (though not the most preferred) are associated with transmission type B. In some embodiments of the disclosure, determining the certain properties of the preferred nodes includes analyzing the most preferred nodes and identifying properties that are common to the most preferred nodes. For example, following the examples above, the AI model may determine that the most preferred nodes are equally split between transmission types A and B. In that case, the AI model may analyze the nodes for other properties, such as details about the transmission, to determine what else may be common among the most preferred nodes.

As shown in block 506, the process flow 500 may include the step of generating the mock transmissions based on the certain properties of the preferred nodes. In some embodiments of the disclosure, the mock transmissions are generated by the AI model. In some embodiments of the disclosure, generating the mock transmissions based on the certain properties of the preferred nodes means that the mock transmissions would be generated with properties that are similar to or the same as one or more of the properties identified as being associated with the most preferred nodes in the tangle network. Essentially, and for example, the stale nodes need to be trained to process future transmissions. The mock transmissions used to train the stale nodes need to fulfill that function. By having the mock transmissions mirror properties of preferred nodes -nodes that are known to be capable of processing transmissions-the mock transmissions can be used to train the stale nodes to act like the preferred nodes. Focusing on the properties of the most preferred nodes in generating mock transmissions can ensure that the stale nodes are trained with the strongest processing properties in the tangle network. In some embodiments, the AI algorithm may also analyze the properties of the stale nodes or least preferred nodes to understand what makes them less preferred. The AI model can compare such ‘weak’ properties with the ‘strong’ properties of the more preferred nodes to generate the best and most appropriate mock transmissions to train each stale node.

FIG. 6 illustrates a process flow 600 for generating mock transmissions based on an analysis of incoming data transmissions, in according with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600. Additionally, and in some embodiments, an AI model (like the AI model shown and described above with respect to FIG. 2) and/or a DLT ledger (like that shown and described above with respect to FIGS. 3A-3B) may perform one or more of the step of process flow 600.

As shown in block 602, the process flow 600 may include the step of analyzing an incoming data transmission. An incoming data transmission is a transmission initiated by a user and introduced into the tangle network to be processed in the tangle network. For example, and in some embodiments, the user may initiate a transmission by inputting details of the transmission into an application via a user device. In some embodiments of the disclosure, the incoming data transmission is analyzed by the AI model. In some embodiments of the disclosure, analyzing the incoming data transmission includes analyzing the various properties of the data transmission. In some embodiments of the disclosure, the properties of the data transmission may be of the same type as the properties of the nodes in the network. For example, the incoming data transmission may be associated with a transmission type, the same way nodes in the tangle network may be associated with a transmission type. In some embodiments, analyzing the incoming data transmission may include analyzing the properties of the incoming data transmission in comparison with the properties of the nodes in the tangle network.

As shown in block 604, the process flow 600 may include the step of determining properties of the incoming data transmission to be used in generating the mock transmissions. In some embodiments of the disclosure, the AI model determines the properties of the incoming data transmission to be used in generating the mock transmissions. The AI model may determine which properties to use based on the properties of prior transmissions. For example, an incoming data transmission may be a resource transaction. The properties of the resource transaction may include type of transaction (transfer, deposit, withdrawal, etc.), amount, account number, location, time, and the like. Based on its analysis of the nodes in the tangle network, the AI model may determine that the properties preferred nodes most have in common are the type of transaction and amount. For example, preferred nodes may be preferred because they are of a certain transaction type. Thus, the AI model may generate mock transmission that are of the same transaction type or similar amount to the incoming data transmission. In some embodiments, the AI model may determine which properties should be used based on the properties of the nodes in the tangle network. For example, and in some embodiments, the AI model may determine that the stale nodes have some properties that are common to the properties of the incoming data transmission and may determine such common properties are not needed to train the stale node. For example, following the example above, the AI model may determine that the stale nodes are associated with transactions of high amounts. The AI model may not need to train it to process transactions of high accounts and may therefore generate mock transmissions that focus on the other properties of the transaction.

As shown in block 606, the process flow 600 may include the step of generating the mock transmissions based on the determined properties of the incoming data transmission. In some embodiments of the disclosure, the mock transmissions are generated by the AI model. In some embodiments of the disclosure, the mock transmissions are generated using only the properties of the incoming data transmission. For example, by training the stale nodes to process similar transmissions as the incoming data transmission at hand, the AI model may teach the stale node to process that incoming data transmission specifically and thus speed up the processing of that transmission so that it would essentially not have to wait for another node for processing. In some embodiments of the disclosure, the mock transmissions are generated using some combination of the properties of the incoming data transmission and the properties of the preferred nodes. In some embodiments, training stale nodes using mock transmissions generated based on the properties of the incoming data transmission may mean training the stale nodes specifically to process that specific incoming data transmission. In some cases, such training could configure the stale nodes to process future transmissions too. In some embodiments, there may be multiple incoming data transmissions and the properties of the multiple incoming data transmissions may be used to generate the mock transmissions. Training stale nodes with mock transmissions generated based on a combination of properties of the incoming data transmission and properties of the preferred nodes could help configure the stale nodes to process the current incoming data transmission as well as other future transmissions.

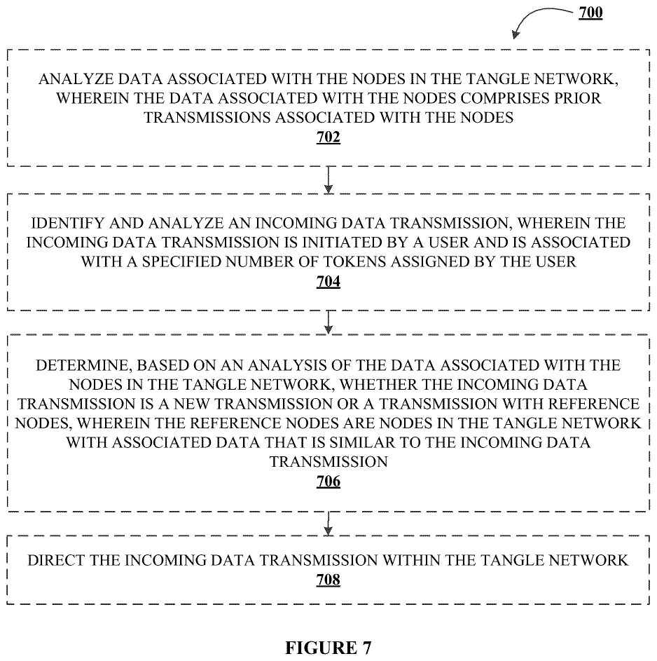

FIG. 7 illustrates a process flow 700 directing incoming data transmissions within the tangle network, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process 700. Additionally, and in some embodiments, an AI model (like the AI model shown and described above with respect to FIG. 2) and/or a DLT ledger (like that shown and described above with respect to FIGS. 3A-3B) may perform one or more of the step of process flow 700.

As shown in block 702, the process flow 700 may include the step of analyzing data associated with the nodes in the tangle network. In some embodiments of the disclosure, data associated with the nodes in the tangle network is analyzed by a smart tipping selection algorithm. In some embodiments of the disclosure, the smart tipping selection algorithm may incorporate artificial intelligence and machine learning elements in the algorithm itself and use such elements to analyze the data. In some embodiments, the data may be analyzed by the AI model, wherein the AI model is separate from the smart tipping selection algorithm. In some embodiments of the disclosure, the smart tipping selection algorithm may work in conjunction with the separate AI model to analyze the data. Data associated with the nodes in the tangle network may include the processing history of the nodes, including data associated with and properties of each prior transmission processed by each node in the tangle network.

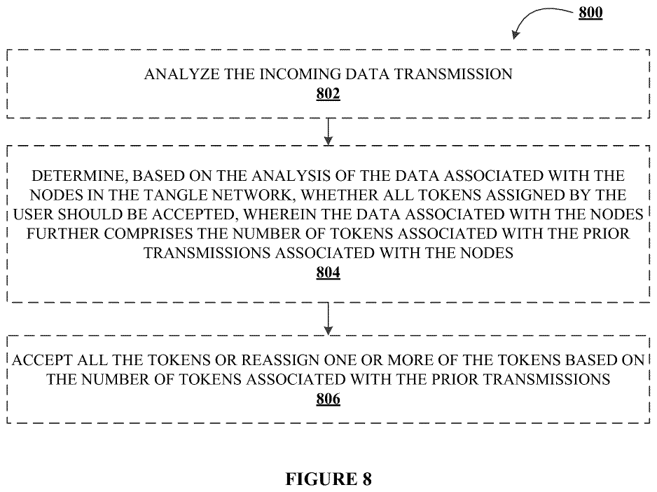

As shown in block 704, the process flow 700 may include the step of identifying and analyzing an incoming data transmission. An incoming data transmission is a transmission initiated by a user and introduced into the tangle network to be processed in the tangle network. In some embodiments of the disclosure, the smart tipping selection algorithm identifies and analyzes the incoming data transmission. In some embodiments, the smart tipping selection algorithm works in conjunction with the AI model to identify and analyze the incoming data transmission. When the user initiates the incoming data transmission, the user may also assign a specified number of tokens to the incoming data transmission. The number of tokens assigned a transmission are directly proportional to the weight or priority that transmission needs to be given within the tangle network (i.e., the more tokens assigned to a transmission, the higher its priority). For example, and in some embodiments, an incoming data transmission with a higher number of tokens (therefore, higher priority) introduced later may be processed before an incoming data transmission with a lower number of tokens (therefore, lower priority) introduced earlier. In some embodiments of the disclosure, the smart tipping selection algorithm may reject and reassign one or more tokens assigned to the incoming data transmission by the user, as further detailed in FIG. 8 and the description of FIG. 8 below.

As shown in block 706, the process flow 700 may include the step of determining whether the incoming data transmission is a new transmission or a transmission with reference nodes. Reference nodes are nodes in the tangle network with associated data that is similar to the data associated with the incoming data transmission. For example, and in some embodiments, if an incoming data transmission is of transmission type A, then all nodes in the tangle network that are of transmission type A may be reference nodes with respect to the incoming data transmission. If the incoming data transmission has at least one reference node in the tangle network, the incoming data transmission is a transmission with reference nodes. If the incoming data transmission has no reference nodes in the tangle network, then it is a new transmission. In some embodiments of the disclosure, whether the incoming data transmission is a new transmission or a transmission with reference nodes is determined by the smart tipping selection algorithm. In some embodiments, the smart tipping selection algorithm may work in conjunction with the AI model. In some embodiments, the smart tipping selection algorithm determines whether the incoming data transmission is a new transmission or a transmission with reference nodes based on an analysis of both the incoming data transmission and all the nodes in the tangle network. For example, the smart tipping selection algorithm may compare its analysis of the incoming data transmission with its analysis of the data associated with each node in the tangle network and nodes associated with the same transmission type as the incoming data transmission may be considered reference nodes. As long as one reference node is found, the smart tipping selection algorithm would classify the incoming data transmission as a transmission with reference nodes.

As shown in block 708, the process flow 700 may include the step of directing the incoming data transmission within the tangle network. In some embodiments of the disclosure, the smart tipping selection algorithm directs the incoming data transmission within the tangle network. In some embodiments of the disclosure, the smart tipping selection algorithm works in conjunction with the AI model to direct the incoming data transmission within the tangle network. In some embodiments of the disclosure, the AI model provides feedback to the smart tipping selection algorithm regarding the AI model's training of stale nodes-such as which nodes the AI model has trained, the properties of the trained nodes, and data associated with the mock transmissions used to train the nodes. In some embodiments of the disclosure, the smart tipping selection algorithm may take into account the AI model's feedback when directing the incoming data transmission. The smart tipping selection algorithm may also consider as a factor the feedback provided by the AI model in determining the most appropriate validator block, secondary validator block, or reserve validator block to direct the incoming data transmission to. In some embodiments of the disclosure, the smart tipping selection algorithm is configured to distribute incoming data transmissions evenly across all nodes in the tangle network. In some embodiments of the disclosure, the smart tipping selection algorithm and the AI model work in conjunction to ensure that all incoming nodes are processed efficiently by either a validator block or a reserve validator block. In some embodiments, the smart tipping selection algorithm directs the incoming data transmission to a specific node in a validator block or reserve validator block. In some embodiments, the incoming data transmission is directed within the tangle network based on whether it is a new transmission or a transmission with references.

If the incoming data transmission is a new transmission, then the incoming data transmission may be directed directly to a reserve validator block. A reserve validator block may comprise one or more reserve validator nodes, where a reserve validator node is a stale node that has been or can be trained by the AI model. In some embodiments of the disclosure, there are no nodes in the tangle network that can process an incoming data transmission that is a new transmission—if there are no nodes in the tangle network associated with transmissions of the same type as the incoming data transmission, for example. In some embodiments, then for example, the reserve validator block would have nodes that can be trained by the AI model using mock transmissions generated based on the properties of the incoming data transmission. In some embodiments of the disclosure, for example, the reserve validator nodes may be stale nodes that have already been trained by the AI model based on properties of the preferred nodes. In some embodiments of the disclosure, the reserve validator block may have nodes previously trained by the AI model that may not be a perfect fit for the incoming data transmission but that would be able to process the incoming data transmission. In some embodiments, and as an example, the AI model can essentially tell (by providing feedback) the smart tipping selection algorithm to send the incoming data transmission to the trained nodes.

If the incoming data transmission is a transmission with reference nodes, then the incoming data transmission may be directed to a validator block. A validator block may comprise active or preferred nodes. In some embodiments of the disclosure, a tangle network may comprise more than one validator block. The smart tipping selection algorithm would have to determine which validator block to send the incoming data transmission to. In determining which validator block to direct the incoming data transmission to, the smart tipping selection algorithm analyzes both the incoming data transmission and the nodes in each validator block. The smart tipping selection algorithm may take into account various factors including at least one of the following: the number of tokens associated with the incoming data transmission, the weightage of the nodes in the validator block, the incoming data transmission's transmission type, and/or the transmission types associated with the nodes in the validator block. The smart tipping selection algorithm, based on all the factors it considers, determines a most appropriate validator block for the incoming data transmission and directs the incoming data transmission to the most appropriate validator block. If, however, the most appropriate validator block is saturated or nearing saturation, then the smart tipping selection algorithm redirects the incoming data transmission to a secondary validator block. The saturation of a validator block is determined by analyzing the volume of traffic to the validator block—if there is a long line of transmissions that are waiting to be processed by the validator block, for example, the validator block may be nearing saturation. In some embodiments of the disclosure, there may be more than one secondary validator blocks. In some embodiments, all validator blocks that are not the most appropriate validator block or the reserve validator block are secondary validator blocks. In some embodiments, if the most appropriate validator block and all the secondary validator blocks are saturated or nearing saturation, the smart tipping selection algorithm may redirect the incoming data transmission to a reserve validator block. For example, and in some embodiments, when an incoming data transmission that is a transmission with reference nodes is redirected to the reserve validator block because the most appropriate validator block and all secondary validator blocks were nearing saturation, then the reserve validator nodes trained on the preferred nodes can process the incoming data transmission.

One example of how the smart tipping selection algorithm may work is as follows. A tangle network may have validator blocks A, B, and C, each of which has nodes associated with transmission type A, and a reserve validator block, with reserve validator nodes. While all three validator blocks have nodes with transmission type A, the nodes in validator block A have higher weightage than the nodes in both validator block B and C, and the nodes in validator block C have higher weightage than the nodes in validator block B. A user initiates an incoming data transmission of transmission type A with a high number of tokens (for example, 10 tokens) assigned. The incoming data transmission is a transmission with existing references. The smart tipping selection algorithm may determine that validator block A, with nodes of the same transmission type as the incoming data transmission and with the highest weightage, is the most appropriate validator block. The smart tipping selection algorithm would direct it there. If, for example, there is already a transmission waiting to be processed by validator block A, the waiting transmission has the same number of tokens as or more tokens than the incoming data transmission, and the other validator blocks don't have a wait, then the smart tipping selection algorithm may redirect the incoming data transmission to validator block C as the next best validator block (the first secondary validator block). If validator block C also has a transmission waiting to be processed that has the same number of tokens as or more tokens than the incoming data transmission, then the smart tipping selection algorithm may redirect the incoming data transmission to validator block B (the second secondary validator block). If, for example, the waiting transmission has less tokens than the incoming data transmission, the smart tipping selection algorithm may redirect the waiting transmission to validator block C instead. In this example, if all three validator block had long lines of transmissions with the same number of tokens as or more tokens than the incoming data transmission waiting to be processed, then instead of leaving the incoming data transmission at the back of the line, the smart tipping selection algorithm may redirect the incoming data transmission to the reserve validator block. The smart tipping selection algorithm may receive feedback from the AI model about which reserve validator nodes have been trained using mock transmissions based on properties of nodes in the most appropriate validator block and send the incoming data transmission to those nodes.

FIG. 8 illustrates a process flow 800 for accepting or rejecting tokens associated with an incoming data transmission, in accordance with an embodiment of the disclosure. In some embodiments, a system (e.g., similar to one or more of the systems described herein with respect to FIGS. 1A-1C) may perform one or more of the steps of process flow 800. For example, a system (e.g., the system 130 described herein with respect to FIG. 1A-1C) may perform the steps of process 800. Additionally, and in some embodiments, an AI model (like the AI model shown and described above with respect to FIG. 2) and/or a DLT ledger (like that shown and described above with respect to FIGS. 3A-3B) may perform one or more of the step of process flow 800.

As shown in block 802, the process flow may include the step of analyzing the incoming data transmission. In some embodiments of the disclosure, the smart tipping selection algorithm analyzes the incoming data transmission. In some embodiments of the disclosure, analyzing the incoming data transmission includes identifying the number of tokens assigned to the incoming data transmission and identifying and analyzing all properties associated with the incoming data transmission, including the type of transmission the incoming data transmission is. For example, a tangle network may process resource transactions. The type of transmission in such a case may include the type of resource transaction. For example, types of resource transactions may include payments, transfers, deposits, withdrawals, and the like.

As shown in block 804, the process flow 800 may include the step of determining whether all tokens assigned to the incoming data transmission by the user should be accepted. In some embodiments of the disclosure, the smart tipping selection algorithm determines whether all the tokens assigned to the incoming data transmission should be accepted. In some embodiments, whether all the tokens assigned to the incoming data transmission should be accepted is determined based on the analysis of the data associated with the nodes in the tangle network. In some embodiments of the disclosure, analyzing data associated with the nodes in the tangle network includes analyzing the tokens associated with each of the prior transmissions introduced into and processed in the tangle network. The smart tipping selection algorithm may, based on its analysis of the incoming data transmission and analysis of the prior transmissions processed in the tangle network, determine that the user assigned too many tokens to the incoming data transmission. In that case, the smart tipping selection algorithm would determine that not all the tokens assigned to the incoming data transmission should be accepted. If the smart tipping selection algorithm determines that the number of tokens assigned to the incoming data transmission are appropriate, based on the number of tokens assigned to prior transmissions, then the smart tipping selection algorithm may determine that all the tokens assigned to the incoming data transmission should be accepted.

As shown in block 806, the process flow 800 may include the step of accepting all the tokens or reassigning one or more of the tokens assigned to the incoming data transmission. In some embodiments of the disclosure, the smart tipping selection algorithm accepts all the tokens or reassigns one or more tokens. If the smart tipping selection algorithm, in the analysis and determination described above, determines that all tokens should be accepted, then the smart tipping selection algorithm accepts all tokens and moves to directing the incoming data transmission within the tangle network. If, on the other hand, the smart tipping selection algorithm determined that the user assigned too many tokens, then the smart tipping selection algorithm may reject and reassign one or more of the tokens. Rejected tokens may be reassigned, i.e., redistributed, to other incoming data transmissions. Thus, in some embodiments, the smart tipping selection algorithm may, upon analysis, determine that, in addition to accepting all the tokens assigned to the incoming data transmission by the user, one or more rejected tokens associated with other incoming data transmissions should be reassigned to the incoming data transmission at hand. In some embodiments of the disclosure, the smart tipping selection algorithm has to determine how many tokens to reject and/or reassign. The smart tipping selection algorithm may make this determination based on the number of tokens associated with prior transmissions. For example, if all prior transmissions of the same type of transmission as the incoming data transmission or with similar properties to the incoming data transmission were assigned tokens that fall within a certain range, 10-20 tokens for example, and the user assigned the incoming data transmission 50 tokens, the smart tipping selection algorithm may reassign a few of the tokens assigned by the user (e.g., 30-40). Those rejected tokens may be reassigned to another incoming data transmission where the smart tipping selection algorithm had determined the user assigned too few tokens, based on prior transmissions. However, as another example, if all prior transmissions of the same type as the incoming data transmission were associated with a number of tokens that fell within a certain range, but the incoming data transmission had a property that coincided with a property of a prior transmission of a different type but that was associated with a number of tokens that was closer to the number of tokens assigned to the incoming data transmission by the user, the smart tipping selection algorithm may determine to all the tokens assigned by the user should be accepted. The smart tipping selection algorithm, utilizing artificial intelligence and machine learning, would continuously learn from each transmission and understand why the transmission was assigned the number of tokens the transmission was assigned. The smart tipping selection algorithm would therefore be trained to understand when an incoming data transmission may not need the full number of tokens assigned by the user. By rejecting some tokens that are not needed for an incoming data transmission and reassigning those rejected tokens to other incoming data transmissions where additional tokens may be needed, the efficiency and overall performance of the tangle network may be improved.

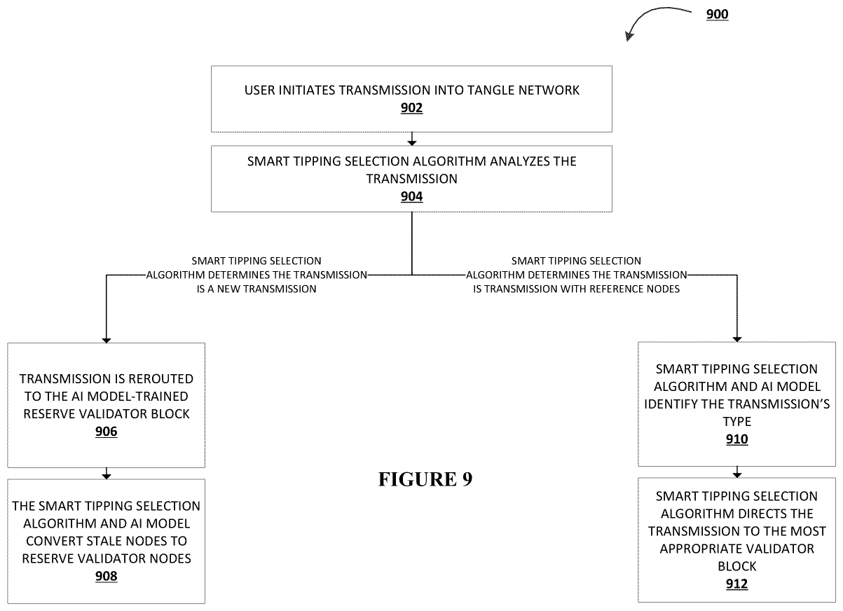

FIG. 9 illustrates a process flow 900 for directing incoming data transmissions within a tangle network, in accordance with an embodiment of the disclosure. In some embodiments, a system (e.g., similar to one or more of the systems described herein with respect to FIGS. 1A-1C) may perform one or more of the steps of process flow 900. For example, a system (e.g., the system 130 described herein with respect to FIG. 1A-1C) may perform the steps of process 900. Additionally, and in some embodiments, an AI model (like the AI model shown and described above with respect to FIG. 2) and/or a DLT ledger (like that shown and described above with respect to FIGS. 3A-3B) may perform one or more of the step of process flow 900.

As shown in block 902, the process flow 900 may include the step of initiating an incoming data transmission. The incoming data transmission may be initiated by a user and introduced into the tangle network. When the user initiates the incoming data transmission, the user may also assign a specified number of tokens to the incoming data transmission. The number of tokens represent the weight the incoming data transmission needs to be given.

As shown in block 904, the process flow 900 may include the step of analyzing the incoming data transmission. In some embodiments of the disclosure, the smart tipping selection algorithm analyzes the incoming data transmission. In some embodiments of the disclosure, analyzing the incoming data transmission includes identifying the number of tokens assigned to the incoming data transmission. In some embodiments, analyzing the incoming data transmission includes identifying and analyzing all properties associated with the incoming data transmission. In some embodiments, the smart tipping selection algorithm also analyzes the nodes in the tangle network, including the processing history of the nodes, the properties of prior transmissions associated with the nodes, and the number of tokens associated with the prior transmissions. A property associated with incoming data transmissions and existing nodes includes transmission type. In some embodiments, the smart tipping selection algorithm may, based on the analysis of the incoming data transmission and the analysis of the nodes in the tangle network, determine that the user assigned too many tokens to the incoming data transmission and reassign one or more tokens to other incoming data transmissions in the tangle network. In some embodiments, the smart tipping selection algorithm, based on the analysis of the incoming data transmission and the analysis of the nodes in the tangle network, determines whether the incoming data transmission is a new transmission or a transmission with reference nodes. Reference nodes are nodes in the tangle network that have one or more properties in common with the incoming data transmission. A transmission with reference nodes, therefore, has at least one node in the tangle network with common properties. A new transmission does not have any nodes in the tangle network with common properties. The smart tipping selection algorithm directs the incoming data transmission based on whether the incoming data transmission is a new transmission or a transmission with reference nodes.

As shown in block 906, the process flow 900 includes the step of routing the transmission to a reserve validator block. An incoming data transmission is routed to a reserve validator block if the smart tipping selection algorithm determines that the incoming data transmission is a new transmission. A new transmission would not have any nodes in the tangle network that can process the new transmission because there are no nodes in the tangle network that has properties in common with the new transmission. Therefore, the smart tipping selection algorithm directs the incoming data transmission to the reserve validator block.

As shown in block 908, the process flow 900 includes the step of converting stale nodes to reserve validator nodes. The incoming data transmission is directed to the reserve validator block because there are no nodes in the tangle network that can process the incoming data transmission. Therefore, the smart tipping selection algorithm and AI model convert the stale nodes in the reserve validator block to reserve validator nodes to process the incoming data transmission. The AI model converts the stale nodes to reserve validator nodes by feeding the stale nodes mock transmissions that were generated by the AI model. The AI model may generate the mock transmission using properties of the incoming data transmission so that the reserve validator nodes will be equipped to process the incoming data transmission.

As shown in block 910, the process flow 900 includes the step of identifying the incoming data transmission's type. The smart tipping selection algorithm, upon determining that the incoming data transmission is a transmission with reference nodes, must direct the incoming data transmission to a validator block. A validator block comprises active nodes, ready to process the incoming data transmission. A tangle network may have more than one validator block. Therefore, the smart tipping selection algorithm must determine which validator block to direct the incoming data transmission to. One way to determine which validator block to direct the incoming data transmission to would depend on the incoming data transmission's transmission type. Therefore, the incoming data transmission is analyzed, and the incoming data transmission's transmission type is first identified. In some embodiments of the disclosure, the smart tipping selection and the AI model work together to identify the incoming data transmission's type.

As shown in block 912, the process flow 900 includes the step of directing the incoming data transmission to the most appropriate validator block. In some embodiments of the disclosure, the smart tipping selection algorithm determines the most appropriate validator block and directs the incoming data transmission accordingly. The most appropriate validator block may be determined based on the transmission type of the incoming data transmission and the transmission type associated with each node in each validator block. For example, a validator block with nodes of the same transmission type as the incoming data transmission may be the most appropriate validator block. In some embodiments of the disclosure, the smart tipping selection algorithm may also consider factors such as the weightage of the nodes in the validator blocks and the token number attached to the incoming data transmission to determine the most appropriate validator block. In some embodiments of the disclosure, the smart tipping selection algorithm may also consider the volume of traffic to each validator block to determine the most appropriate validator block.

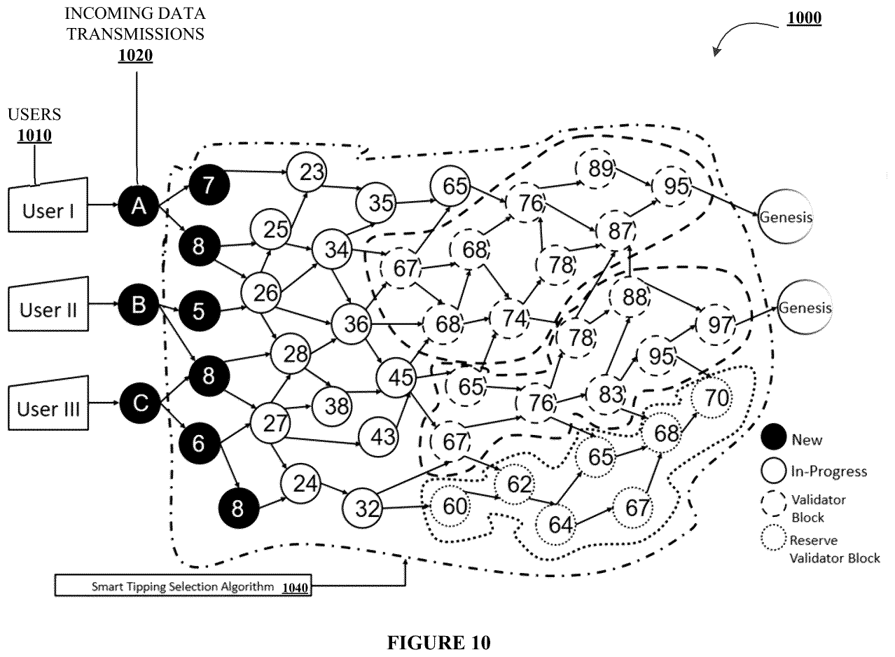

FIG. 10 illustrates a tangle network architecture 1000, in accordance with an embodiment of the disclosure. In some embodiments, a system (e.g., similar to one or more of the systems described herein with respect to FIGS. 1A-1C) may perform one or more of the steps of the tangle network architecture 1000. For example, a system (e.g., the system 130 described herein with respect to FIG. 1A-1C) may perform the steps of tangle network architecture 1000. Additionally, and in some embodiments, an AI model (like the AI model shown and described above with respect to FIG. 2) and/or a DLT ledger (like that shown and described above with respect to FIGS. 3A-3B) may perform one or more of the step of tangle network architecture 1000.

As shown in architecture 1000, multiple users 1010 may initiate one or more incoming data transmissions 1020 all at the same time. The smart tipping selection algorithm 1040 directs the incoming data transmissions throughout the tangle network. The smart tipping selection algorithm 1040 ensures that all incoming data transmissions are evenly distributed across the nodes in the tangle network.

The smart tipping selection algorithm 1040 and the AI model work together to convert stale nodes into active reserve validator nodes that form a reserve validator block (both depicted in FIG. 10 by dotted lines), such that the reserve validator block and the reserve validator nodes work alongside the preferred nodes in the validator blocks (both depicted in FIG. 10 by dashed lines) to evenly process all transmissions.

In some embodiments of the disclosure, an incoming data transmission has to traverse through the network to be fully processed, i.e., achieve genesis. In some embodiments of the disclosure, a transmission that has achieved genesis becomes a node in the tangle network, which can later process other transmissions.

In some embodiments of the disclosure, a stale node may be a node that has achieved genesis but is of an uncommon transmission type and has therefore fallen out of use. In standard transmission processing with a standard tipping selection algorithm, a stale node may be a transmission that never achieved genesis and got dropped in the tangle network because of high levels of saturation in the tangle network, for example. However, in embodiments of the present disclosure, with the smart tipping selection algorithm 1040, all transmissions would be fully processed and would not be dropped in the tangle network. In this way, over time, there may be fewer stale nodes that need to be converted to active nodes.

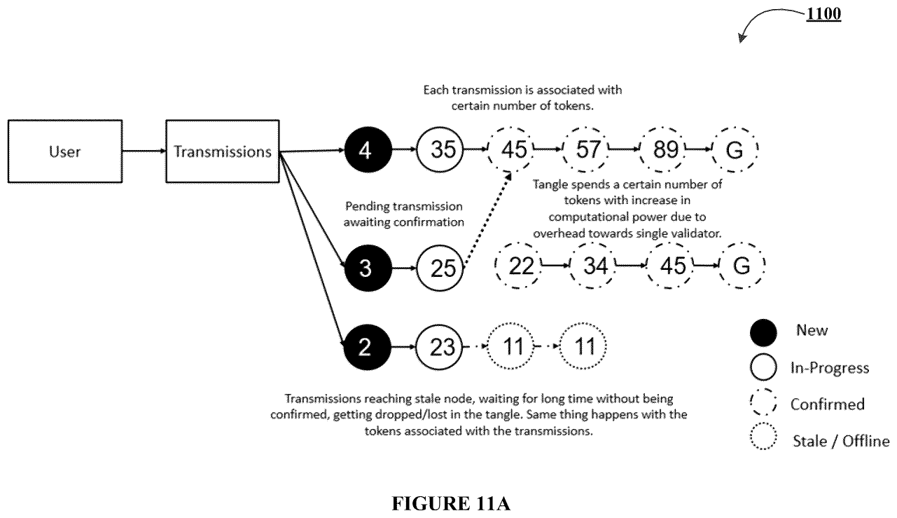

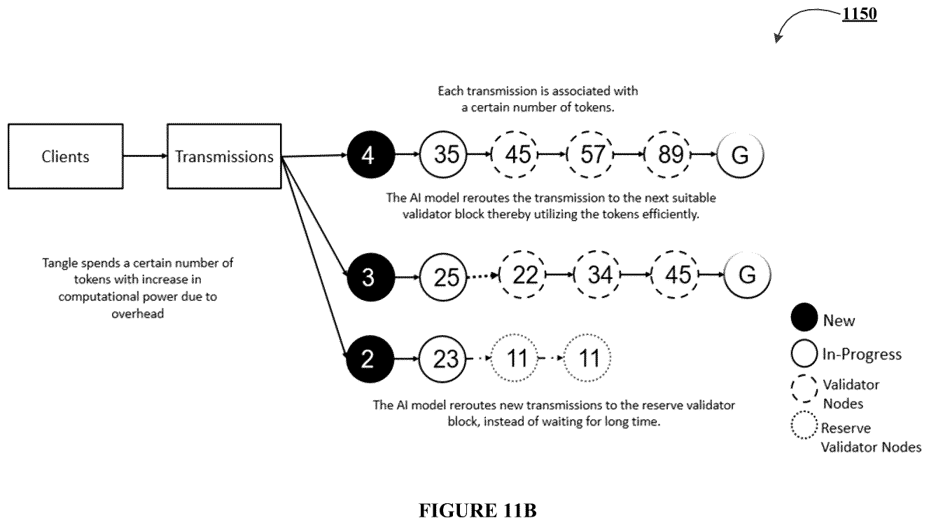

FIGS. 11A-11B illustrate a process flow 1100 and 1150, respectively, for directing incoming data transmissions within a tangle network with token utilization, in accordance with an embodiment of the disclosure. In some embodiments, a system (e.g., similar to one or more of the systems described herein with respect to FIGS. 1A-1C) may perform one or more of the steps of process flow 1100. For example, a system (e.g., the system 130 described herein with respect to FIG. 1A-1C) may perform the steps of process 1100. Additionally, and in some embodiments, an AI model (like the AI model shown and described above with respect to FIG. 2) and/or a DLT ledger (like that shown and described above with respect to FIGS. 3A-3B) may perform one or more of the step of process flow 1100.

As shown in process flows 1100 and 1150, incoming data transmissions are depicted by the fully black circles, transmissions currently being processed are depicted by the black outlined circles, confirmed transmissions are depicted by the dashed and dotted line circles, and inactive stale nodes are depicted by the dotted line circles. Confirmed transmissions are nodes in the tangle network that can process incoming data transmissions. The number in each circle depicts the number of tokens associated with the transmission or the weight of the node.

FIG. 11A illustrates a process flow that depicts how a standard tipping selection algorithm directs transmissions through a tangle network and how tokens are utilized in this process. The transmissions with the highest token numbers go to the nodes with the highest weights. For example, 4 goes to 35, which goes to 45. However, transmissions with high token numbers but not as high as some of the other transmissions in progress may also be directed to the nodes with the highest weights, even when there are other nodes that are capable of processing the transmission available. In this example, 25 is also being directed to 45, which means 45 now has to process 35 and 25, along with 4 and 3 after as well. The tangle network uses more computational power for higher weighted nodes to process more transmissions. Thus, more computational power is used to process lower token, and therefore lower priority transmissions. Meanwhile, the transmission with the lowest token number, in this case 2, goes to the node with the least weights, which in this case leads to stale nodes. Low token number transmissions, and even high token number transmissions, may end up going to low weighted nodes if the processing times for the higher weighted nodes are too long. As a result, multiple transmissions are inefficiently waiting to be processed by one node while active nodes are going unused. Additionally, low token number transmissions may get dropped in the tangle network because they are unable to be processed because of high wait times or stale nodes. Dropped transmissions may become stale nodes, exacerbating the problem.

FIG. 11B, on the other hand, illustrates a process flow that depicts how the smart tipping selection algorithm provided for in this disclosure directs transmissions through the tangle network and how tokens are utilized in the process. The smart tipping selection algorithm distributes transmissions evenly across the tangle network. In this example, 4 goes to 35 which is being processed by 45, while 3 goes to 25 which is being processed by 22. The smart tipping selection algorithm recognizes that 45 has a transmission in progress and one in line and reroutes 25 to 22 so that 35 and 25 can be processed simultaneously. In this way, no one block of nodes builds up a queue of transmissions and all blocks of nodes in tangle network are actively working to process transmissions. Additionally, in this example, 2 goes to 23, which is being processed by the reserve validator nodes, instead of waiting for the preferred nodes. The process depicted in FIG. 11B addresses the various problems presented by the process depicted in FIG. 11A, with the smart tipping selection algorithm improving the overall performance of the tangle network and ensuring that all transmissions are processed in an efficient manner.

Thus, present embodiments of the disclosure discussed in detail above, the present disclosure provides for automatically and dynamically converting non-working nodes to active nodes in a distributed network to improve the overall performance of the network and ensure all transmissions are efficiently processed by the network. Specifically, the disclosure uses an AI model to identify stale nodes in a tangle network by first analyzing all nodes in the tangle network, generating mock transmissions and training the stale nodes using the mock transmissions to convert the stale, unused nodes into active, usable nodes. In some embodiments, the AI model may analyze preferred nodes (nodes currently in use) in the tangle network, determine properties of the preferred nodes that cause the preferred nodes to be usable, and use the determined properties to generate the mock transmissions. In some embodiments, the AI model may analyze an incoming data transmission, determine properties of the incoming data transmission, and use the determined properties to generate the mock transmissions.

The disclosure also comprises a smart tipping selection algorithm that analyzes data associated with all the nodes in the tangle network, identifies and analyzes an incoming data transmission, determines whether the incoming data transmission is new transmission or is a transmission with reference nodes, and directs the incoming data transmission within the tangle network based on the determination. In some embodiments, the smart tipping selection algorithm directs transmissions with reference nodes to a validator block and in other embodiments, the smart tipping selection algorithm directs a new transmission to a reserve validator block. In some embodiments, the smart tipping selection algorithm has to decide which validator block to direct the incoming data transmission to, and makes that decision based on one or more factors, including, among others, the number of tokens associated with the incoming data transmission, weight of the preferred nodes, and the transmission type associated with the incoming data transmission and the nodes in the validator block. The smart tipping selection algorithm first directs the incoming data transmission to the most appropriate validator block but may redirect to a secondary validator block if the most appropriate validator block is nearing saturation, or to a reserve validator block is the most appropriate validator block and all secondary validator blocks are nearing saturation. In some embodiments, the reserve validator block comprises reserve validator nodes, which are stale nodes trained by the AI model. In some embodiments, the incoming data transmission, initiated by a user, is associated with a specified number of tokens assigned to the incoming data transmission by the user. In further embodiments, the smart tipping selection algorithm analyzes the number of tokens associated with prior transmissions similar to the incoming data transmission that have already been processed in the tangle network and determines whether to accept all the incoming data transmission's tokens or not. Upon determining not to accept all the incoming data transmission's tokens, the smart tipping selection algorithm can reassign one or more of the tokens to one or more other incoming data transmissions. In some embodiments of the disclosure, the AI model provides feedback to the smart tipping selection algorithm regarding the stale nodes it trains, and the smart tipping selection algorithm may consider such feedback in determining how to direct the incoming data transmission. The smart tipping algorithm and AI model may work together to distribute incoming data transmissions evenly across all nodes of the tangle network and to ensure that all incoming data transmissions are processed.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatically and dynamically converting non-working nodes to active nodes in a distributed network, the system comprising:
a memory device comprising non-transitory computer-readable medium with computer-readable program code stored thereon;
at least one processing device operatively coupled to the at least one memory device and at least one communication device, wherein when executed, the computer-readable code is configured to cause the at least one processing device to:
analyze, by an artificial intelligence (AI) model, nodes in a tangle network;
identify, by the AI model, at least one stale node, wherein the at least one stale node is a node in the tangle network that is a currently unused node;
generate, by the AI model, mock transmissions; and
train, by the AI model, the stale nodes using the mock transmissions, wherein such training configures the stale nodes to process future transmissions.

2. The system of claim 1, wherein the computer-readable code is further configured to cause the at least one processing device to:
analyze, by the AI model, preferred nodes, wherein the preferred nodes are nodes in the tangle network that are currently in use;
determine, by the AI model, certain properties of the preferred nodes, wherein the certain properties of the preferred nodes indicate the reasons for the current use of the preferred nodes; and
generate, by the AI model, the mock transmissions based on the certain properties of the preferred nodes.

3. The system of claim 1, wherein the computer-readable code is further configured to cause the at least one processing device to:
analyze, by the AI model, an incoming data transmission;
determine, by the AI model, properties of the incoming data transmission; and
generate, by the AI model, the mock transmissions based on the properties of the incoming data transmission.

4. The system of claim 1, wherein the system further comprises a smart tipping selection algorithm, wherein the smart tipping selection algorithm is configured to cause the at least one processing device to:
analyze data associated with the nodes in the tangle network, wherein the data associated with the nodes comprises prior transmissions associated with the nodes;
identify and analyze an incoming data transmission, wherein the incoming data transmission is initiated by a user and is associated with a specified number of tokens assigned by the user;
determine, based on an analysis of the data associated with the nodes in the tangle network, whether the incoming data transmission is a new transmission or a transmission with reference nodes, wherein the reference nodes are nodes in the tangle network with associated data that is similar to the incoming data transmission; and
direct the incoming data transmission within the tangle network.

5. The system of claim 4, wherein the AI model provides feedback to the smart tipping selection algorithm regarding the AI model's training of stale nodes, and wherein the smart tipping selection algorithm directs the incoming data transmission within the tangle network based on the feedback.

6. The system of claim 4, wherein the smart tipping selection algorithm is further configured to cause the at least one processing device to:
analyze the incoming data transmission;
determine, based on the analysis of the data associated with the nodes in the tangle network, whether all tokens assigned by the user should be accepted, wherein the data associated with the nodes further comprises the number of tokens associated with the prior transmissions associated with the nodes; and
accept all the tokens or reassign one or more of the tokens based on the number of tokens associated with the prior transmissions.

7. The system of claim 4, wherein the smart tipping selection algorithm is configured to cause the at least one processing device to direct the incoming data transmission to a validator block upon determining that the incoming data transmission is the transmission with reference nodes.

8. The system of claim 4, wherein the smart tipping selection algorithm is configured to cause the at least one processing device to direct the incoming data transmission to a reserve validator block upon determining that the incoming data transmission is the new transmission.

9. The system of claim 7, wherein the reserve validator block comprises reserve validator nodes, and wherein the reserve validator nodes are stale nodes that are trained by the AI model using the mock transmissions.

10. The system of claim 7, wherein the smart tipping selection algorithm, directs the incoming data transmission to a most appropriate validator block, wherein the most appropriate validator block is determined based on one or more factors, wherein the one or more factors comprises at least one of:
the number of tokens associated with the incoming data transmission;
weightage of the preferred nodes;
a transmission type of the incoming data transmission; or
one or more transmission types associated with the nodes in the validator block.

11. The system of claim 10, wherein the smart tipping selection algorithm redirects the incoming data transmission to one of one or more secondary validator blocks in an instance where the most appropriate validator block is saturated or is nearing saturation, wherein the saturation is determined by analyzing the volume of traffic to the most appropriate validator block.

12. The system of claim 11, wherein the smart tipping selection algorithm redirects the incoming data transmission to a reserve validator block if all of the most appropriate validator block and the one or more secondary validator blocks are saturated or are nearing saturation.

13. The system of claim 4, wherein the smart tipping selection algorithm is further configured to distribute incoming data transmissions evenly across all nodes of the tangle network.

14. The system of claim 4, wherein the smart tipping selection algorithm and the AI model work in conjunction to ensure all incoming data transmissions are processed by either a validator block or a reserve validator block.

15. A computer implemented method for automatically and dynamically converting non-working nodes to active nodes in a distributed network, the computer implemented method comprising:
analyzing, by an artificial intelligence (AI) model, nodes in a tangle network;
identifying, by the AI model, at least one stale node, wherein the at least one stale node is a node in the tangle network that is a currently unused node;
generating, by the AI model, mock transmissions; and
training, by the AI model, the stale nodes using the mock transmissions, wherein such training configures the stale nodes to process future transmissions.

16. The computer implemented method of claim 15, further comprising:
analyzing, by the AI model, preferred nodes, wherein the preferred nodes are nodes in the tangle network that are currently in use;
determining, by the AI model, certain properties of the preferred nodes, wherein the certain properties of the preferred nodes indicate the reasons for the current use of the preferred nodes; and
generating, by the AI model, the mock transmissions based on the certain properties of the preferred nodes.

17. The computer implemented method of claim 15, further comprising:
analyzing, by the AI model, an incoming data transmission;
determining, by the AI model, properties of the incoming data transmission; and
generating, by the AI model, the mock transmissions based on the properties of the incoming data transmission.

18. The computer implemented method of claim 15, further comprising:
analyzing data associated with the nodes in the tangle network, wherein the data associated with the nodes comprises prior transmissions associated with the nodes;
identifying an incoming data transmission, wherein the incoming data transmission is initiated by a user and is associated with a specified number of tokens assigned by the user;
determining, based on an analysis of the data associated with the nodes in the tangle network, whether the incoming data transmission is a new transmission or a transmission with reference nodes, wherein the reference nodes are nodes in the tangle network with associated data that is similar to the incoming data transmission; and
directing the incoming data transmission within the tangle network.

19. A computer program product for automatically and dynamically converting non-working nodes to active nodes in a distributed network, wherein the computer program product comprises at least one non-transitory computer-readable medium having computer-readable program code portions embodied therein, the computer-readable program code portions which when executed by a processing device are configured to cause the processing device to:
analyze, by an artificial intelligence (AI) model, nodes in a tangle network;
identify, by the AI model, at least one stale node, wherein the at least one stale node is a node in the tangle network that is a currently unused node;
generate, by the AI model, mock transmissions; and
train, by the AI model, the stale nodes using the mock transmissions, wherein such training configures the stale nodes to process future transmissions.

20. The computer program product of claim 19, wherein the computer-readable program code portions which when executed by a processing device are further configured to cause the processing device processing device to:
analyze data associated with the nodes in the tangle network, wherein the data associated with the nodes comprises prior transmissions associated with the nodes;
identify an incoming data transmission, wherein the incoming data transmission is initiated by a user and is associated with a specified number of tokens assigned by the user;
determine, based on an analysis of the data associated with the nodes in the tangle network, whether the incoming data transmission is a new transmission or a transmission with reference nodes, wherein the reference nodes are nodes in the tangle network with associated data that is similar to the incoming data transmission; and
direct the incoming data transmission within the tangle network.
